(19) United States
(12) Patent Application Publication
(10) Pub. No.: US 2013/0149689 A1
(43) Pub. Date: Jun. 13, 2013

(54) POP UP EDUCATIONAL CONTENT AND/OR DICTIONARY ENTRY FOR IMAGES AND COMPLEMENTING TRIVIA

(71) Applicant: Lee M. DeGross, Fort Lee, NJ (US)

(72) Inventor: Lee M. DeGross, Fort Lee, NJ (US)

(21) Appl. No.: 13/709,171

(22) Filed: Dec. 10, 2012

Related U.S. Application Data
(60) Provisional application No. 61/630,378, filed on Dec. 10, 2011.

(51) Int. Cl. G09B 7/00

(52) U.S. Cl. CPC G09B 7/00
USPC 434/362

(57) ABSTRACT

A convenient process that helps a user to understand more about images (36) (61) displayed on a computer screen (12). A challenging and fun complementing trivia (44) is included to enliven the educational experience. When an image (36) is selected, at least 1 pop up space appears (FIG. 2). The pop up space presents an educational content and at least 1 trivia (38). An educational content example is a corresponding word (40) of the selected image. Other educational content examples are a dictionary entry such as a pronunciation (40), a definition (64), and an etymology (54). More educational content examples are a meaning, other reference entries, a narrative, a sound effect, and a separate image (46). The trivia (48) can be presented in multiple and varied formats. The trivia (48) can be related to the selected image, a pop up space educational content like a separate image, or another trivia.

### CROSS-REFERENCE TO RELATED APPLICATION:

This application claims the benefit of provisional patent application Ser. No. 61/630,378, filed 2011 Dec. 10 by the present inventor.

### FEDERALLY SPONSORED RESEARCH

None

### SEQUENCE LISTING OR PROGRAM

None

### BACKGROUND

1. Field

This application relates to the field of computers, specifically the creation of digital processes.

2. Description of Prior Art

The less relevant prior art will be discussed first and will progress to the more significant prior art. For brevity, the words “selection”, “selecting”, “selects”, and “selected” encompasses all of the various selection methods of a computer.

The first prior art are “The Oxford Pop up English Language Reference Shelf©”, “The Oxford Pop up French German Spanish Dictionary Shelf©”, “The Pop up Concise Oxford English-Duden German Dictionary©”, and “The Pop up Oxford English-Duden German Dictionary©”. These prior art available on CD-ROMs are made by the same companies.

The multi-language Oxford dictionaries provide translations of a word. The “Oxford Pop up English Language Reference Shelf©” has a thesaurus, a dictionary of quotations, and a world encyclopedia that the other Oxford dictionaries do not have.

The 4 Oxford prior arts, through various functions, provide a floating pop up window with a search field for entering words, menus, and the resulting dictionary and reference information.

Alternatively, integrated with any Microsoft™ Windows™-based application, the 4 Oxford prior arts simply require double-clicking on a word. In another alternative, integrated with Microsoft's™ Internet Explorer™, the 4 Oxford prior arts merely require placing a cursor over a word on a web-page. After these selections, a pop up appears with the menus and the resulting dictionary and reference information. A disadvantage of both alternatives is that their functions of double-clicking or placing a cursor over a word are limited to the specific Microsoft™ products.

A disadvantage of the 4 Oxford prior arts is that they do not provide many essential dictionary entries. Two examples are syllable breaks and pronunciation symbols. Another disadvantage is that sound is not utilized, such as for a reading of a definition.

Another disadvantage is that photographs, comics, 3 dimensional images, moving images, animations, films, movies, videos, cartoons, claymations, stop-action imagery, 3 dimensional action images, and computer generated action images are not provided in the pop up window for a word.

Another disadvantage of the 4 Oxford prior arts is their products are dry learning experiences, and are not challenging, entertaining or fun.

The primary disadvantage of the 4 Oxford prior arts is that they show results solely and exclusively for the displayed words or phrases, oftentimes within a text. They do not provide thesaurus, dictionary, and other reference results for any displayed images.

The next prior art is the book titled “Merriam-Webster's Visual Dictionary” which shows, for example, a picture and its definition. The book is advertised as the “first visual dictionary to incorporate dictionary-scale definitions”. A disadvantage is this prior art is a book and does not utilize a computer. Another disadvantage is that its contents are limited to 6,000 illustrations under 17 general categories. Another disadvantage is the book is a dry learning experience, and is not challenging, entertaining or fun.

Evidently and surprisingly, in the prior art, there is no existing product of a computer dictionary for illustrations or any computer applications of it.

The next prior art is U.S. patent application Ser. No. 10/773,695, titled “Method and system for interactive teaching and practicing of language listening and speaking skills”. Its abstract states.
“An interactive language instruction system employs a setting and characters with which a learner can interact with verbal and text communication. The learner moves through an environment simulating a cultural setting appropriate for the language being learned. Interaction with characters is determined by a skill level matrix to provide varying levels of difficulty. A visual dictionary allows querying of depicted objects in the environment for verbal and text definitions as well as testing for skill determination.”

This application displays words, phrases, text, and images on a computer screen to interact with. The application describes “a display unit . . . which displays text and graphical information”. The application teaches displayed texts that are connected to the graphical information. The application does not describe or teach results that are solely and exclusively about or for displayed images.

A disadvantage of this application is that its purpose is directed to the different utility of a learner's listening and speaking skills. As a result another disadvantage is that the learner must interact, often by actually speaking, with persons and text onscreen in a simulated village setting. Another disadvantage is that the dictionary features are limited to the name of the object, and any associated sounds for listening. Another disadvantage is that most dictionary or thesaurus entries are not presented. Among these are synonyms, senses, pronunciation symbols, syllable divisions, parts of speech, inflected forms, variants, example quotations, and etymologies, to name a few. Another disadvantage, and befitting its particular utility on listening and speaking skills, is that separate objects or separate images about the selected object are not presented. Another disadvantage is the application is not entertaining or fun.

The next prior art are the patents and patent applications about different computer visual and picture dictionaries which are listed in the attached Information Disclosure Statement. These visual and picture dictionary patents and patent applications describe displayed words, phrases, text and images on a computer screen. They do not describe or teach displayed images that are disjoined and separate from such words, phrases, or text.

Each of the aforementioned prior art references also have the disadvantage of not providing any stimulating digital trivia to enliven the learning experience. The next prior art is the book titled “Trivia Café: 2000 Questions For Parties, Travel, Fundraisers, School Events”. The book has 2000 trivia questions and answers for contests in social settings, and for travelers. A disadvantage is this prior art is a book and does not utilize a computer. Another disadvantage is that it is limited to the 2000 trivia. Another disadvantage is that the book has a limited number of setups, which are a game format, trivia for individual travelers, and more difficult question sets. Another disadvantage is that the book does not have any educating dictionary entries for images.

The next prior art is called “SuperMunchers Trivia” which is available on a CD-ROM. This computer trivia game combines arcade action and trivia questions. Players must control their Munchers and munch the answer to questions while evading Troggles, who can eat the Munchers, A player's trivia knowledge is tested by munching as many answers as it, can. This trivia game displays words, phrases, text and images on the computer screen. The game does not display images that are disjoined and separate from such words, phrases, or text. The disadvantage is that the trivia game does not have any educating dictionary entries for images.

The next prior art are the patents and patent applications about different computer trivia versions which are listed in the attached Information Disclosure Statement. These trivia patents and patent applications describe displayed words, phrases, text and images on a computer screen. They do not describe or teach displayed images that are disjoined and separate from such words, phrases, or text. The disadvantage of these trivia patents and patent applications is that none describe or teach presenting any dictionary entries for images.

This concludes the prior art section.

### SUMMARY

When an image or moving image is selected on a computer screen, convenient pop up spaces presents educational content. The pop up spaces contain stimulating and fun related trivia in many formats. The pop up space educational content includes a corresponding word representing the selected image. The educational content includes dictionary entries such as pronunciations, end of line word divisions, syllable breaks, parts of speech, variants, definitions, senses, antonyms, usages, etymologies, and quotations. Additional educational content are separate images or separate moving images such as drawings, illustrations, photographs, animations, films, digital video works, and computer generated images. Further educational content includes other reference entries, descriptions, narratives, sound effects, extemporaneous works, and at least two different languages. The pop up spaces presenting the educational content and trivia provide learning, informative, and entertainment results.

### DRAWINGS—FIGURES

FIG. 1 shows a computer.

FIG. 2 shows a cursor placed over an image on a screen. The resulting pop up spaces presents educational content and complementing trivia.

FIG. 3 shows pop up spaces presenting educational content, a picture, and complementing trivia in another format.

FIG. 4 shows pop up spaces presenting educational content, 2 different languages, and complementing trivia in another format.

FIG. 5 shows pop up spaces presenting educational content, 6 synonyms, and complementing trivia in 2 other formats.

FIG. 6 shows a cursor placed over a different signaled image. The resulting pop up spaces presents educational content, 6 different synonyms, and complementing trivia in another format.

FIG. 7 shows a flowchart outlining the simple, fast, and convenient process of the application.

DRAWINGS -- Reference Numerals

| 10 | computer | 12 | screen |
|---|---|---|---|
| 14 | central processing unit | 16 | keyboard |
| 18 | mouse | 22 | operating system bar |
| 24 | Uniform Resource Locator field | 26 | web browser features |
| 28 | scroll bar | 34 | cursor |
| 36 | digital video image | | |
| 38 | at least 1 pop up space presenting educational content, and | | |
| | complementing trivia related to the selected image or related to | | |
| | an educational content | | |
| 40 | pop up space menu with corresponding phrase and 3 choices | | |
| 42 | pop up space presents a part of speech entry of a verb and an | | |
| | explanation of the corresponding phrase that is an extemporaneous | | |
| | work | | |
| 43 | syllable break entries of the corresponding phrase | | |
| 44 | pop up space presents trivia in a multiple choice format | | |
| 46 | separate image for selected “(1) image” from the menu | | |
| 48 | pop up space presents trivia in a true or false format | | |
| 50 | pop up space menu with corresponding word and 3 choices | | |
| 52 | pop up space presents the 1^{st} trivia within a serial format | | |
| 54 | pop up space presents an etymology and showing 2 different | | |
| | languages | | |
| 58 | pop up space presents 6 synonyms | | |
| 59 | pop up space presents the 2^{nd} trivia within the serial format | | |
| | and a score result | | |
| 60 | pop up space presents trivia related to the 2^{nd} trivia in a format | | |
| | having a hint and an input field | | |
| 61 | special distinguishing signal | | |
| 62 | signaled picture image | | |
| 63 | pop up space menu with different corresponding word and 2 choices | | |
| 64 | pop up space presents an end of line word division with 2 senses and | | |
| | definitions | | |
| 66 | pop up space presents a trivia in a format without requiring a | | |
| | response | | |
| 68 | pop up space presents other trivia information in a non-interactive | | |
| | format | | |
| 70 | 2^{nd} pop up space menu with 3 choices for the selected word “steep” | | |
| | from a previous pop up space | | |
| 72 | pop up space presents a definition | | |
| 74 | pop up space presents 6 synonyms of “steep” | | |
| 80 | flowchart block 1 | 82 | flowchart block 2 and results |

### DETAILED DESCRIPTION—PREFERRED EMBODIMENT

The present application which is titled “POP UP EDUCATION CONTENT AND/OR DICTIONARY ENTRY FOR IMAGES AND COMPLEMENTING TRIVIA” is a computer and internet creation that is a process, method, and a system. The purpose is to create a process that provides educational content such as meanings, dictionary entries, or visual information, and complementing trivia when a cursor is placed over an image or moving images. The process provides learning, informational, and fun results. For brevity, the title is hereinafter designated “Education and Trivia”. Also for brevity, the “image or moving image” is hereinafter designated “image” or “images”.

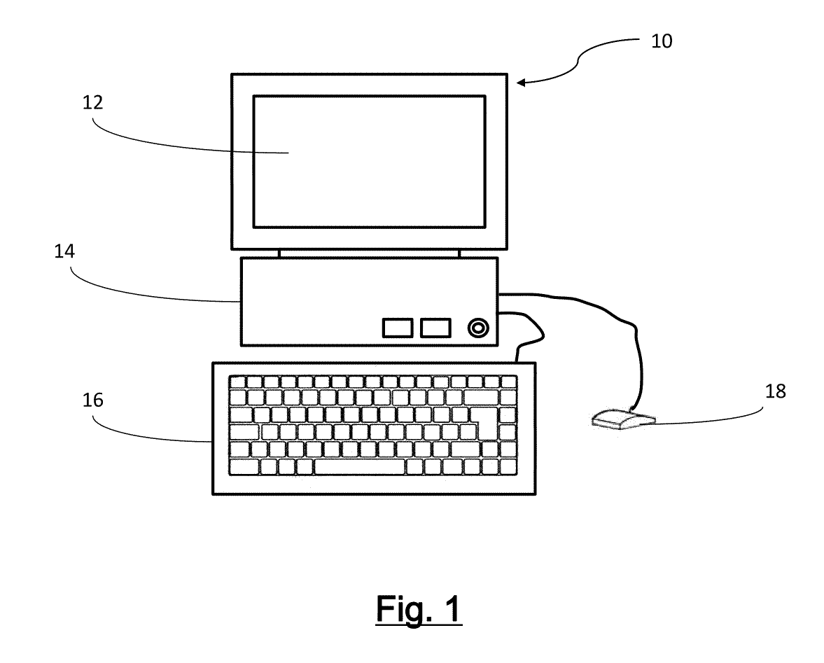

First a static physical description of a computer and the internet will be discussed. As shown in FIG. 1, the computer is a ubiquitous machine that has undergone constant changes in form, speed, and memory size and this will continue as computers evolve presently and in the future. Computers come in all shapes and sizes but share four essential characteristics consisting of the input, processing, memory, and output functions.

Computers range in size from small hand-size personal digital assistants (PDA's) to a briefcase-like laptop PC (personal computer) to a typical desktop PC. Larger computers like workstations and mainframes do not count for the Education and Trivia because their size is inappropriate for the intended audience of everyday computer and internet users.

The selection methods of a computer include and are not limited to a keyboard, mouse, placing a cursor over the intended selection, touchscreen, touchpad, touch-button, stylus, voice recognition, voice activated selection method, and other such inputs.

The computer can add peripheral devices like external hard drives, external speakers, and video recorders.

The descriptions will start with the largest computers (the desktop computer) and work downwards in size to end with the PDA's. All of these computers have internet capabilities but it must be emphasized that the Education and Trivia is applicable to both computers without the internet and to computers that have the internet.

The desktop computer (or desktop microcomputer) has a monitor and screen, and is the primary output device. The desktop computer typically has a box-like slab called a Central Processing Unit (CPU) that houses the processing and memory parts. The CPU is often placed on a desk or on the floor.

Positioned in front of the monitor or CPU is a keyboard. The keyboard is an input device that enters letters, numbers, and other symbols. The mouse is another input device that allows the user to move the cursor to select, point, and draw on the computer screen. The mouse is a very common device and is usually the size of a person's palm. The mouse is placed on a flat surface (like a desk) so when it is moved, the cursor on the computer screen also moves correspondingly. It usually has a few buttons that allow the cursor on the computer screen to “click” or select a particular spot on the screen.

The laptop PC, by now a very common machine, combines all of the features or devices found on a desktop PC system described above (with the current exception of a printer) into one single unit that is typically the size of a large notebook. Laptops are designed to be a portable PC with a very thin monitor and screen that, when closed, is usually positioned face down facing the keyboard. A hinge or other similar device typically combines the keyboard and monitor and the laptop looks like an open clamshell when opened.

Personal digital assistants (PDA's), also called handhelds, have the portability of laptops but, for example, are designed in a much smaller hardcover book shape, usually without a monitor on a hinge or other similar device.

PDA's are frequently designed to be small enough to fit in a user's hand or a shirt pocket. PDA's are primarily organizers that allow a user to do scheduling functions, act like a notepad, store phone numbers, calculate, use many software applications, and a host of other uses.

PDA's have features that are combined with various other electronic gadgets like cellular phones, pagers, and the like. Cellular phones are portable wireless telephones. Pagers are small devices that alert the user to return a call.

For PDA's accessing a webpage, the screen typically shows just a portion of the webpage. The PDA's screen may get the rest of the webpage by using a scrolling function to go across, or up and down.

Virtually all desktop computers, laptops, and PDA's can access the internet and intranet, often by wireless means. Desktop computers, laptops, and PDA's are usually powered using an electrical outlet, sometimes in combination with batteries (usually rechargeable), or only the batteries.

The internet and intranet that a computer is part of will now be described briefly. The idea of the internet is simple, a vast network of computers of many types that are connected and are able to interact with one another. The whole of the internet could probably be written about in a series of large books. For the purposes of the Education and Trivia the following definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The most relevant feature regarding the internet for the Education and Trivia is the World Wide Web (WWW). The WWW, with its ability to handle graphics and hyperlinks is included here since the Education and Trivia will mostly use WWW webpages and capabilities. The internet spans many countries, has of thousands of networks, has millions of computer users, and will continue to grow and improve.

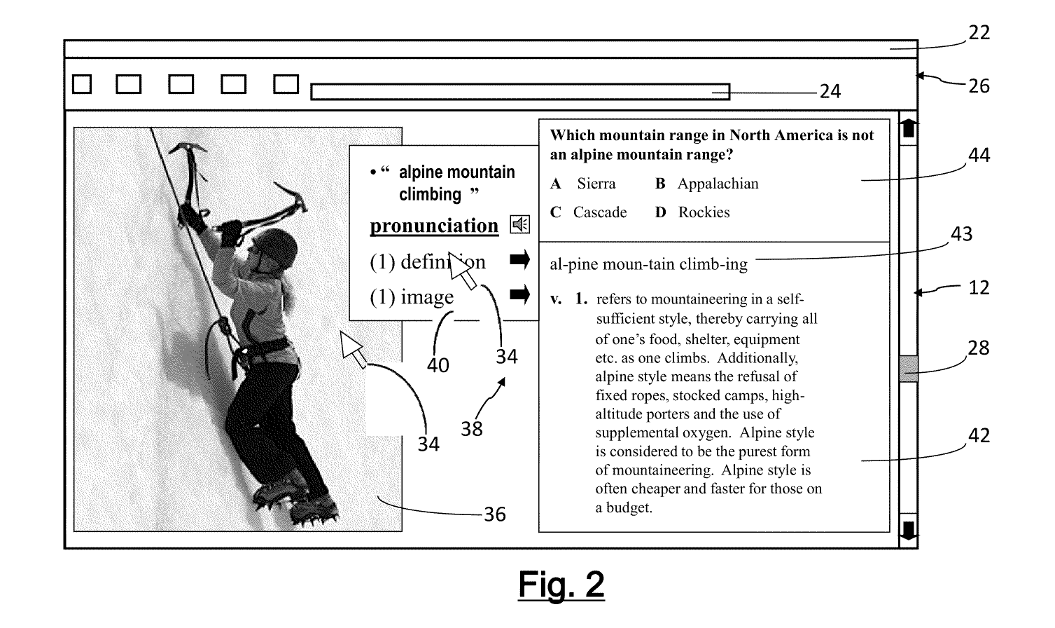

FIG. 2 shows what a webpage looks like with blank shapes on a computer screen with the internet accessed. There are the standard web browser features like buttons, icons, and an input field for entering internet URL addresses (or internet domain names). A shaded navigation scrolling bar is shown on the right of the webpage. Displayed outside the webpage is the operating system bar. A cursor is shown larger than actual size.

The WWW is navigated or surfed with the help of a web browser. A webpage's address is accessed when its URL (Uniform Resource Locator) or domain name is invoked on the browser's domain name locator. The Education and Trivia is not limited to WWW webpages, but can be implemented and accessed on internet pages without the WWW.

The Education and Trivia can also be implemented on intranet webpages. The following definition of the intranet is from the Dictionary of Computer and Internet Terms. It defines the intranet as, “the opposite of INTERNET; a network confined to a single organization (but not necessarily to a single site). Intranets often include web pages, so a web browser can be used to view the content. This makes the intranet appear just the same as part of the World Wide Web; the only difference is that it is not accessible to those outside the organization.”

A basic description of the computer hardware, the internet, and intranet has been discussed. Also for inclusion is accessing internet/television hybrids and any wireless networks. The Education and Trivia is not limited as to the type of computer on which it runs, and not limited as to the type of network accessed.

In the preferred embodiment of the Education and Trivia, images displayed on a computer screen are utilized. The displayed images are unattached, unconnected, and outside of any pop up spaces.

The images includes and are not limited to photographs, pictures, illustrations, drawings, paintings, charts, maps, diagrams, 3 dimensional images, digital photographs, digital pictures, comics, moving images, animations, films, movies, videos, cartoons, claymation, stop-action imagery, 3 dimensional moving images, digital video works, and computer generated images.

### Operation—Preferred Embodiment

In the preferred embodiment, the Education and Trivia provides a simple and fast process for a user to get the educational content for displayed images and for presenting complementing trivia.

The Education and Trivia operates when a user selects an image. At least 1 pop up space appears that can present the educational content of a corresponding word, phrase, or meaning representing the selected image. The pop up space can present other educational content such as dictionary entries, other reference entries, various meanings, or separate images.

The pop up spaces are the spaces that pop up to exhibit the Education and Trivia. The pop up spaces need not always be a strictly rectangular or window shape. The pop up spaces can take many forms, shapes, and sizes. The pop up spaces include and are not limited to overlapping spaces, multiple pop up spaces, 3 dimensional spaces, spaces that look like images or moving images such as billowy clouds, and any changing or moving shapes of the pop up spaces.

The pop up spaces can contain menus with various choices to present the educational content and/or trivia in an organized manner. The drag and selection method can be used to make a choice on the menus. This method slides the cursor from one selection to another point to select a choice. If no clicking is required to trigger the initial pop up spaces, later clicks or selections by the user may be necessary to get additional, subsequent pop up spaces.

The educational content of dictionary entries that can be presented in the pop up spaces includes and are not limited to main entries, syllabic or syllable breaks, end of line word divisions, parts of speech, pronunciations, pronunciation symbols, variants, homographs, definitions, senses, synonyms, antonyms, etymologies, usages, idioms, suffixes, prefixes, inflected forms, example sentences, and illustrative quotations. These are merely the prominent examples of the dictionary entries.

More examples of the dictionary entries includes and are not limited to binomials, cognate cross-references, directional cross-references, synonymous cross-references, cutback inflected forms, inflectional cross-references, functional labels, stylistic labels, capitalization labels, subject labels, temporal labels, regional labels, lightface types, major stresses, minor stresses, centered periods, run-on entries, small capitals, usage notes, and verbal illustrations.

The pop up space educational content can be other reference entries that includes and are not limited to almanacs entries, encyclopedias entries, compilations entries, summaries entries, etymologies entries, reviews entries, criticisms entries, treatises entries, maps entries, and directories entries.

The pop up space educational content can be figurative, nonliteral, and wordplay terms and expressions that includes and are not limited to abbreviations, abbreviated letterings, acronyms, initials or initialisms, monograms, abridgements, slangs, condensations, cropped words and phrases, clipped words and phrases, short form words and phrases, anagrams, palindromes, semordnilaps, lexigrams, alphagrams, ambigrams, pangrams, metaphors, similes, analogies, puns, double entendres, figures of speech, buzzwords, jargons, lingos, artistic idioms, malapropisms, and spoonerisms. The figurative expressions can be about the selected images or about the other pop up space educational content.

The pop up space educational content can be all information that includes and is not limited to literature, information on any subject, information on any person, information on any peoples, and information on new emerging knowledge.

The pop up space educational content can be separate images that convey a meaning for the selected images, or the educational content or the trivia presented in the pop up spaces. These separate images includes and are not limited to photographs, pictures, illustrations, drawings, paintings, charts, maps, diagrams, 3 dimensional images, digital photographs, digital pictures, comics, moving images, animations, films, movies, videos, cartoons, claymation, stop-action imagery, 3 dimensional moving images, digital video works, and computer generated images.

In addition the separate images includes and are not limited to visual expressions of ideas, concepts, processes, thinking, thoughts, metaphysics, spatial motions, immaterial things, actions, enactments, stories, plays, plots, tales, jokes, and tall tales.

The pop up spaces containing the separate images can be used to augment the other educational content, or be used in pop up spaces without the other educational content. The mode used is the one that best helps a user to understand the selected image.

A sound system can be utilized for the pronunciation of words or phrases in the pop up spaces. Examples of other sound effects include and are not limited to narrations, voice-overs, and music about the selected images or about the pop up space educational content and trivia. The sound effects can be accessed by selecting a speaker icon in the pop up space.

The next feature is the sources of the educational content effectuated in the pop up spaces. One source is from published or professional works like a standard dictionary.

Another source includes and is not limited to other reference works like almanacs, encyclopedias, thesauruses, compilations, subject oriented dictionaries, dictionaries of expressions, subject oriented summaries, subject oriented compilations, treatises, maps, directories, monographs, and thesis publications. Any other reference works that are a source of information for the pop up spaces' words, phrases, terms, person, people, and separate images can be implemented.

Another group of sources are from all communication mediums, communication technologies, communication expressions, individuals, emerging slang, and emerging new research.

Another group of sources is for the figurative expressions presented in the pop up spaces. The sources are specific reference works that includes and are not limited to abbreviation dictionaries, anagram dictionaries, and dictionaries of metaphors. Any other reference works that are a source of the figurative expressions can be utilized. Additional sources include and are not limited to emerging and trending slang, and individuals who originated a figurative expression.

Another source of the pop up space educational content or the trivia is extemporaneous, which are productions or works from the ad hoc creativity of people, writers, editors, artisans and artists.

Of course, not all of the above mentioned educational features are used at once. The features represent options that can be used to best assist a user to understand the selected images or the pop up space educational content. The features chosen depend, to a large degree, on the age, language and makeup of the intended audience. The wishes of the writers, editors, producers, and other people can also be factors.

The intended audience can be people of many ages. The Education and Trivia can be calibrated to a level of difficulty with respect to the age of the intended audience.

Another intended audience can be for people of innumerable professional occupations. The Education and Trivia can be calibrated to the level of difficulty and sophistication with respect to the intended audiences of the innumerable professional occupations. A few occupational examples are physicians, computer programmers, carpenters, airplane pilots, and organic biologists.

The pop up spaces can use at least two different languages or dialects from among all the languages or dialects in the world, past and present. This benefits a person learning a different language.

Any educational content presented in the pop up space can be selected, which would trigger its own pop up space presenting further educational content or trivia. The selection can have its own distinctive signal to denote that latent pop up space information exists for it.

While learning educational content like definitions is highly important with respect to the displayed selected images, a trivia is inherently unimportant. Thus trivia, as an adjective meaning, is trivial.

The pop up spaces contain complementing or complementary trivia. The trivia challenges a person and is an engaging, entertaining time. The trivia is not only fun, but in many ways can have educational qualities because the person can learn something new. The trivia enlivens the dry and boring experience that is often a part of education.

The trivia can be related to the selected images, or related to the educational content presented in the pop up spaces such as the corresponding word, the dictionary entries, or the separate images. The trivia can even be related to the original trivia itself or can be related to other trivia.

Any trivia presented in the pop up space can be selected, which would trigger its own pop up space presenting further educational content or trivia. The selected trivia can have its own distinctive signal to denote that latent pop up space information exists for it.

The trivia can be presented in many formats, and includes and is not limited to the following example formats.

One format has a trivia question with multiple choice answers and when a choice is selected, then subsequently showing the result. Another format has a true or false trivia question and when an answer is selected, then subsequently showing the result. Another format has the trivia question and when the answer is inputted, then subsequently showing the result. Another format has the trivia question with a hint feature that can either display the hint information or display a “hint” link, or something similar, which can be selected to show the hint information. Another format has a series of trivia questions and answers, then subsequently showing a score result. Another format shows trivia information that is non-interactive. This format has trivia without the question and answer or response features.

Thus the pop up spaces that present the educational content and the trivia cooperate to make learning about images more educating and exciting.

In FIG. 2, the cursor is placed over a digital video image of a climber on an ice mountain. A pop up space presents a menu with the corresponding phrase for the selection of “alpine mountain climbing”. This menu has the choices of pronunciation (with a speaker icon), (1) definition, and (1) image. The cursor is next placed over the (1) definition choice. A 2^{nd} pop up space shows a trivia question related to “alpine mountain climbing” with 4 possible answers that can be selected. A 3^{rd} pop up space presents the syllable breaks of “alpine mountain climbing”, verb part of speech, and 1 definition that is an extemporaneous work.

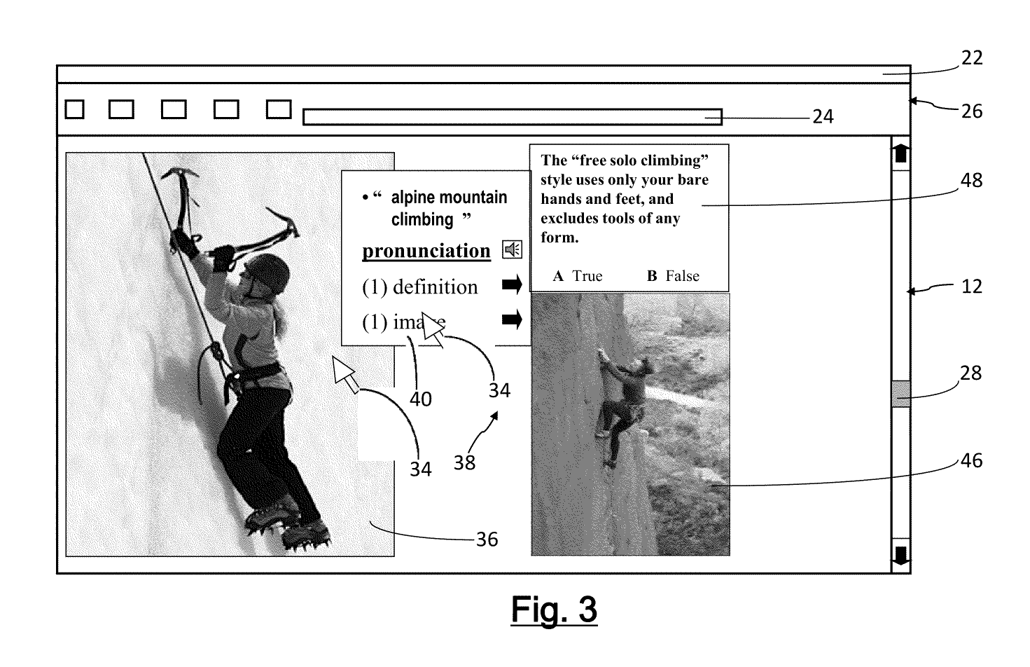

In FIG. 3, the cursor is placed over the (1) image choice in the pop up space menu from FIG. 2. A 2^{nd} pop up space presents a separate picture image of a person alpine mountain climbing on a rock surface. A 3^{rd} pop up space shows a true or false trivia question related to the separate picture image.

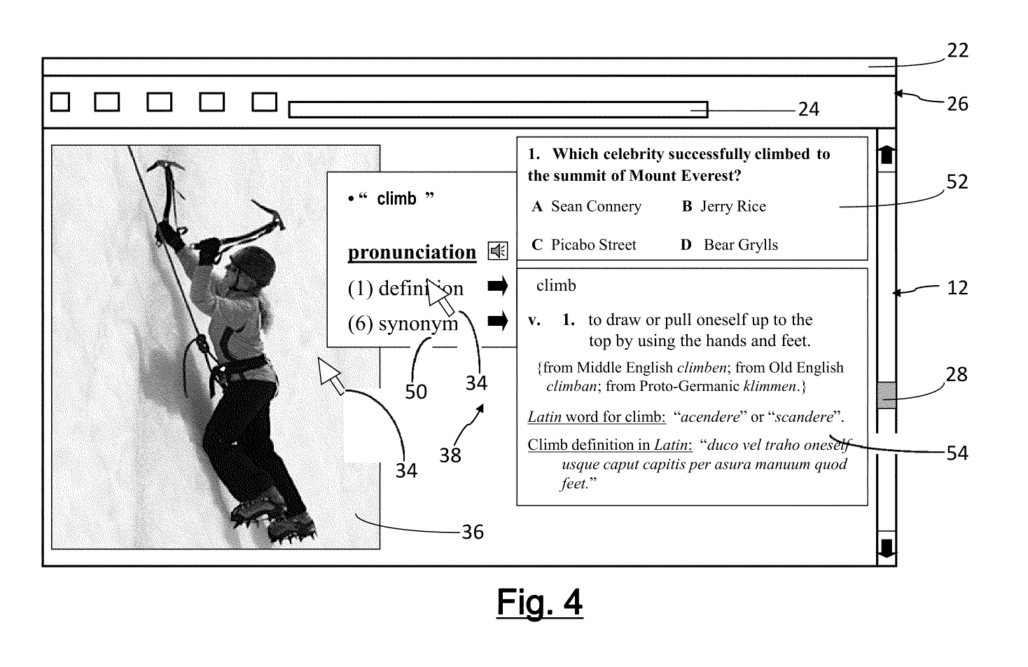

In FIG. 4, the cursor is placed over the mountain climbing scene from FIGS. 2 and 3. In an optional example, a pop up space presents a menu with the corresponding word of “climb”. This menu has the choices of pronunciation (with a speaker icon), (1) definition, and (6) synonyms. The cursor is next placed over the (1) definition choice. A 2^{nd} pop up space shows the first of two serial trivia. This trivia question is related to “climb” with 4 possible answers. A 3^{rd} pop up space presents the “climb” entry, verb part of speech, 1 definition, an etymology, 2 Latin words for “climb”, and the “climb” definition in Latin.

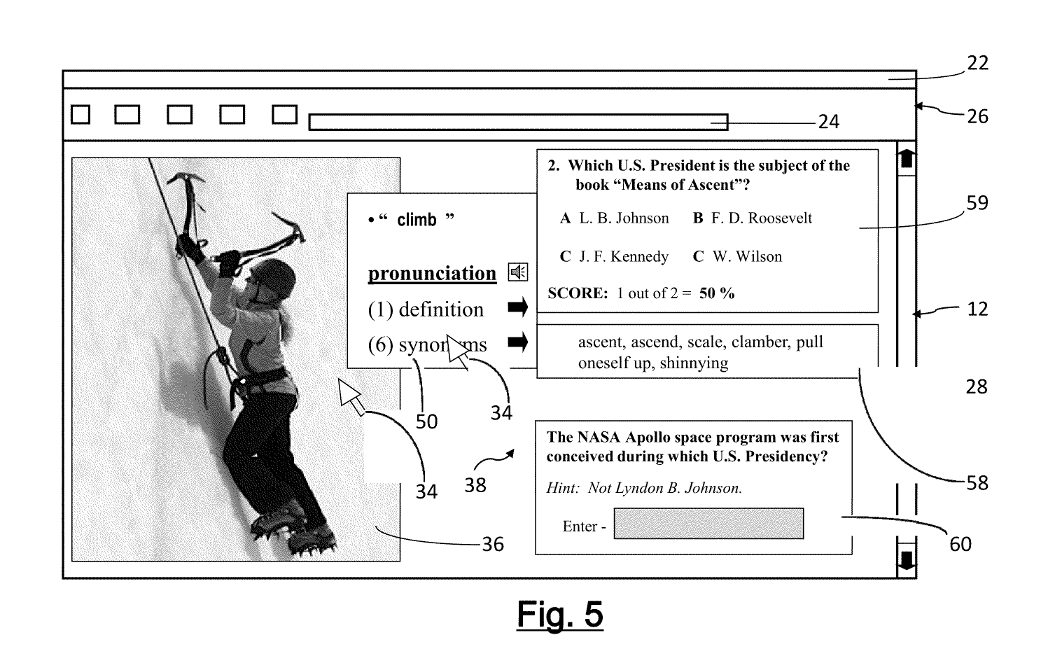

In FIG. 5, the cursor is placed over the (6) synonym choice in the pop up space menu from FIG. 4. A 2^{nd} pop up space presents the 6 synonyms. A 3^{rd} pop up space shows the second of two serial trivia. This trivia question is related to the “ascent” synonym with 4 possible answers. The pop up space also shows the score of the two trivia from FIGS. 4 and 5. The FIGS. 4 and 5 trivia is an example of the serial format. A 4^{th} pop up space shows trivia related to the “U.S. President” and “L. B. Johnson” from the trivia in the 3^{rd} pop up space in a format with a displayed hint and an input field.

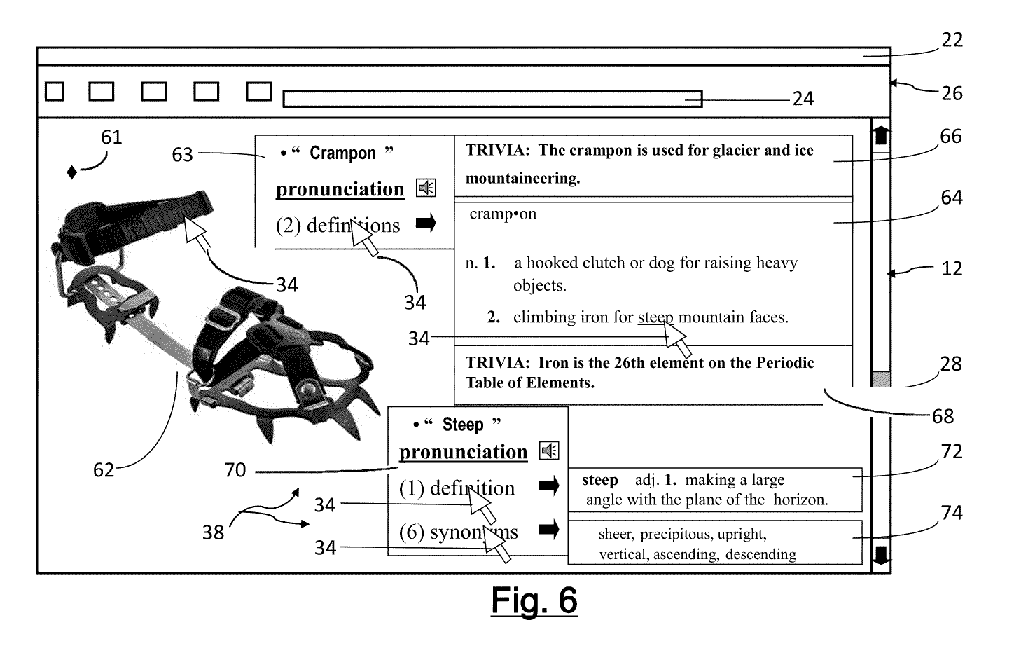

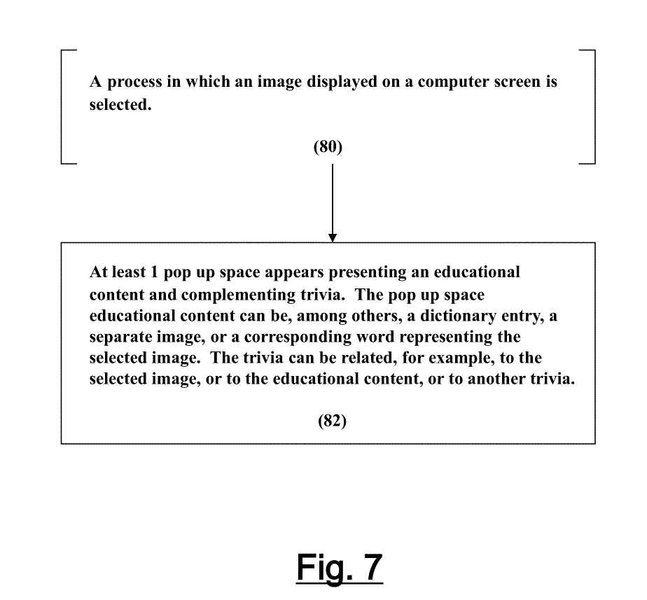

In FIG. 6, the cursor is placed over a signaled image of a crampon. A pop up space presents a menu with the corresponding word “crampon”. This menu has the choices of pronunciation (with a speaker icon) and (2) definitions. The cursor is next placed over the (2) definitions choice. A 2^{nd} pop up space presents end of line word division of “crampon”, noun part of speech, and 2 senses and definitions. A 3^{rd} pop up space shows trivia information related to “crampon” without a question and answer format. A 4^{th} pop up space shows another trivia that is non-interactive or without response features. This trivia is related to the “iron” from the 2^{nd} pop up space. The cursor is next placed over the word “steep” from the 2^{nd} pop up space. A 5^{th} pop up space presents a menu with “steep”, and has the choices of pronunciation (with a speaker icon), (1) definition, and (6) synonyms. The cursor is next placed over the (1) definition choice and a 6^{th} pop up space presents the “steep” entry, adjective part of speech, and 1 definition. The cursor is next placed over the (6) synonyms choice and a 7^{th} pop up space presents the 6 synonyms of “steep”. In FIG. 7, a flowchart of 2 blocks describes the simple steps, features, options, and results of the process.

### Alternative Embodiment

An alternative embodiment does not require every image displayed on the computer screen to implement an Education and Trivia. Instead only certain, or relatively difficult or hard-to-understand images implement it. This embodiment lessens user overexposure, and reduces digital file and memory sizes. This selectivity speeds up digital download and upload times. The embodiment's images can indicate the latent presence of the Education and Trivia with a special signaling feature, such as the symbol “♦” placed next to the images. To further distinguish the signal, it can be colored red, for instance.

### Advantages

A number of advantages of some embodiments of the Education and Trivia are:
(a) for images on a computer screen, to display educational content, and complementing fun trivia in a fast and convenient process;
(b) when images are selected, pop up spaces appear nearby displaying educational content and trivia;
(c) the educational content can be dictionary entries like definitions, senses, syllable breaks, pronunciations, end of line word divisions, parts of speech, synonyms, antonyms, etymologies, variants, usages, idioms, and illustrative quotations;
(d) the educational content can be other reference entries like almanacs entries, encyclopedia entries, thesaurus entries, translation or multi-lingual dictionaries entries, subject-oriented references entries, compilations entries, and summaries entries;
(e) the educational content can be the corresponding word representing the selected images, useful and relevant meanings, descriptions, explanations, and sound effects such as narrations or voice-overs;
(f) the educational content can be separate images such as photographs, illustrations, paintings, drawings, comics, charts, maps, diagrams, films, videos, digital video works, animations, claymations, stop-actions, and cartoons;
(g) the pop up space educational content and/or dictionary entries adds value to a digital property;
(h) the fun and challenging trivia can be presented in multiple and varied formats, such as a series of questions with hints and a displayed score at the finish;
(i) the trivia is related to the selected images, or the pop up space educational content, or other trivia, or the original trivia itself;
(j) the entertaining trivia adds value and increases the popularity of a digital property;
(k) to calibrate the level of difficulty of the pop up space educational content and trivia with respect to the age of the intended audience;
(l) to customize the pop up space educational content and trivia with respect to the occupation of the intended audience;
(m) when a pop up space feature is selected, to display the feature's own pop up spaces with further information or trivia;
(n) the sources of the pop up space educational content or the trivia can be unconventional such as from all communication expressions, individuals, emerging slang, emerging new research, and be extemporaneous;
(o) the pop up spaces can show larger sized text and larger sized separate images, particularly for the visually impaired. Also its colors can be enhanced and adjusted to aid in viewing;
(p) the pop up spaces use at least two different languages; and
(q) an embodiment that does not require every image to implement an Education and Trivia. Instead only certain, relatively difficult or hard-to-understand images implement it. This embodiment lessens user overexposure, and reduces digital file and memory sizes. The selectivity speeds up digital download and upload times. Special signaling features are shown on or next to the images to indicate that a latent Education and Trivia exists for them.

### Conclusions, Ramifications, and Scope

Accordingly, the reader will see that the Education and Trivia provides a fast convenient way of acquiring the educational content and various meanings of the images on a computer screen. The always popular and fun trivia is presented in the convenient pop up space.

If a user is in the dark about the meaning of an image, the Education and Trivia will help matters. The user simply selects the image to instantly get the assistance of the pop up space to understand it. The trivia makes the learning experience more enjoyable.

Although the above description contains many specificities, these should not be construed as limiting the scope of the embodiments, but as merely providing exemplifications of some of the presently preferred embodiments. Many other variations are possible. For example, instead of limiting the pop up space to the corresponding word for the selected images, entire corresponding sentences, paragraphs, or pages can represent the images. These can re-interpret, present a revisionist history, provide a behind the scenes commentary, or give another perspective about the images.

Thus the scope of the embodiments should be determined by the appended claims and their legal equivalents, rather than by the examples given.

I claim:

1. A process, comprising:
a. providing a computer,
b. utilizing an image on a screen,
c. implementing at least 1 pop up space on said screen,
d. implementing an educational content substantially about said image on said screen, and
e. enabling a user to substantially select said image on said screen which triggers said at least 1 pop up space substantially presenting said educational content substantially about said image.

2. The process of claim 1 further including presenting on said screen a trivia in said at least 1 pop up space, and said trivia is substantially related to said image, said educational content, or any other trivia.

3. The process of claim 2 wherein said trivia is non-interactive or presented without requiring a response.

4. The process of claim 2 wherein said trivia is interactive and shows a question and a plurality of answers with at least 1 correct answer in said plurality of answers.

5. The process of claim 2 wherein said at least 1 pop up space substantially presents said educational content of a dictionary entry, and said dictionary entry is a part of speech, a definition, or any other dictionary entry.

6. The process of claim 2 wherein said at least 1 pop up space substantially presents said educational content of a reference entry, and said reference entry is a thesaurus entry, a compilation entry, or any other reference entry.

7. The process of claim 2 wherein said at least 1 pop up space substantially presents said educational content of a separate image, and said separate image is a photograph, a video, or any other image.

8. The process of claim 2 wherein said at least 1 pop up space substantially presents said educational content of a description, an extemporaneous work, or any other information.

9. The process of claim 2 wherein said at least 1 pop up space substantially presents said educational content of a meaning, a dictionary sense entry, a dictionary syllable break entry, or a voice-over.

10. The process of claim 2 wherein said at least 1 pop up space substantially presents said educational content of a reference entry, and said reference entry is an etymology entry, an almanac entry, a directory entry, or a summary entry.

11. A system, comprising:
a computer,
utilizing an image on a screen,
implementing at least 1 pop up space on said screen,
implementing an educational content substantially about said image on said screen,
and
when said image on said screen is selected said at least 1 pop up space appears presenting said educational content substantially about said image.

12. The system of claim 11 further including presenting a trivia in said at least 1 pop up space, and said trivia is substantially related to said image, said educational content, or any other trivia.

13. The system of claim 12 wherein said trivia is interactive and shows a question and an input field for entering an answer.

14. The system of claim 12 wherein said at least 1 pop up space presents said educational content of a substantially corresponding word for said image or a substantially corresponding meaning for said image.

15. The system of claim 12 wherein said at least 1 pop up space presents said educational content of a dictionary entry, and said dictionary entry is a pronunciation, a definition, or any other dictionary entry.

16. The system of claim 12 wherein said at least 1 pop up space substantially presents said educational content of a reference entry, and said reference entry is a thesaurus entry, an encyclopedia entry, or any other reference entry.

17. The system of claim 12 wherein said at least 1 pop up space presents said educational content of a separate image, and said separate image is an illustration, an animation, or any other visual expression.

18. The system of claim 12 wherein said at least 1 pop up space presents said educational content of a narrative, an extemporaneous work or any other information.

19. The system of claim 12 wherein said at least 1 pop up space and said trivia substantially uses at least 2 different languages.

20. The system of claim 12 further including utilizing said computer accessed to an internet, an intranet, or any other network.
